(19) United States
(12) Patent Application Publication
(10) Pub. No.: US 2025/0198737 A1
(43) Pub. Date: Jun. 19, 2025

(54) STRAIN GAUGE

(71) Applicant: MINEBEA MITSUMI Inc., Nagano (JP)

(72) Inventors: Aya ONO, Nagano (JP); Toshiaki ASAKAWA, Nagano (JP); Atsushi KITAMURA, Nagano (JP); Akiyo YUGUCHI, Nagano (JP); Shigeyuki ADACHI, Nagano (JP)

(21) Appl. No.: 18/844,601

(22) PCT Filed: Mar. 10, 2023
(86) PCT No.: PCT/JP2023/009325

§ 371 Date: Sep. 6, 2024

(30) Foreign Application Priority Data
Mar. 14, 2022 (JP) 2022-039237

(51) Int. Cl. G01B 7/16; G01L 1/22

(52) U.S. Cl. CPC G01B 7/18; G01L 1/2293

(57) ABSTRACT

A strain gauge includes a substrate made of a resin, and a resistor situated on one surface side of the substrate and formed of a film that includes Cr, CrN, and Cr₂N. An elastic modulus of the substrate is greater than 9.8 GPa.

### TECHNICAL FIELD

The present invention relates to a strain gauge.

### BACKGROUND

The use of strain gauges has been known for adhering to objects to be measured. For example, a strain gauge may be used as a sensor for detecting strain of a material, or a sensor for detecting an ambient temperature (for example, see Patent Document 1).

### RELATED-ART DOCUMENTS

### Patent Documents

Patent Document 1: Japanese Unexamined Patent Application Publication No. 2001-221696

### SUMMARY

### Problem to be Solved by the Invention

Although a metal substrate or a resin substrate is used in the strain gauge, creep may occur in the strain gauge that uses the resin substrate. The creep is a phenomenon in which strain changes over time when a constant load acts on the strain gauge under a constant temperature condition. The creep may result in a measurement error in the strain gauge.

In view of the above situation, the present invention is created, and an object of the present invention is to provide a strain gauge capable of reducing creep.

### Means for Solving the Problem

A strain gauge according to one embodiment of the present disclosure includes a substrate made of a resin, and a resistor situated on one surface side of the substrate and formed of a film that includes Cr, CrN, and Cr₂N. An elastic modulus of the substrate is greater than 9.8 GPa.

### Effects of the Invention

In a disclosed technique, a strain gauge capable of reducing creep can be provided.

### BRIEF DESCRIPTION OF THE DRAWINGS

FIG. 1 is a plan view illustrating a strain gauge according to a first embodiment.

FIG. 2 is a cross-sectional view (part 1) illustrating the strain gauge according to the first embodiment.

FIG. 3 is a diagram for describing a method for measuring a creep amount and a creep recovery amount.

FIG. 4 is a diagram showing the study results for the creep amount and the creep recovery amount.

FIG. 5 is a cross-sectional view (part 2) illustrating the strain gauge according to the first embodiment.

### MODE FOR CARRYING OUT THE INVENTION

Hereinafter, embodiments for carrying out the invention will be described with reference to the drawings. In each drawing, the same components may be denoted by the same numerals. In each drawing, an X direction, a Y direction, and a Z direction that are orthogonal to one another may be defined. In this case, in the X direction, a starting point (initial point) side of an arrow may be referred to as a −X side, and an ending point (terminal point) side of the arrow may be referred to as a +X side. The same condition as the X direction applies to each of the Y direction and the z direction. In the description for each of the drawings, description of the same components as those already described may be omitted.

### First Embodiment

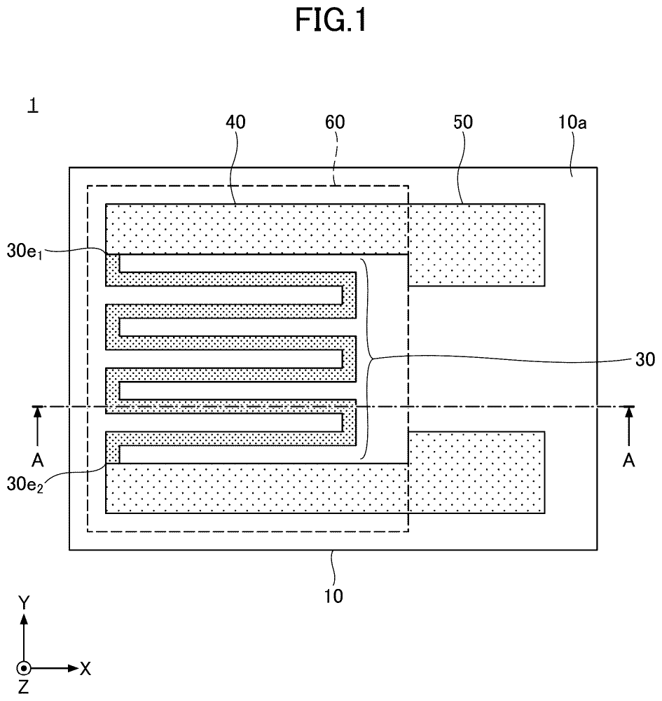

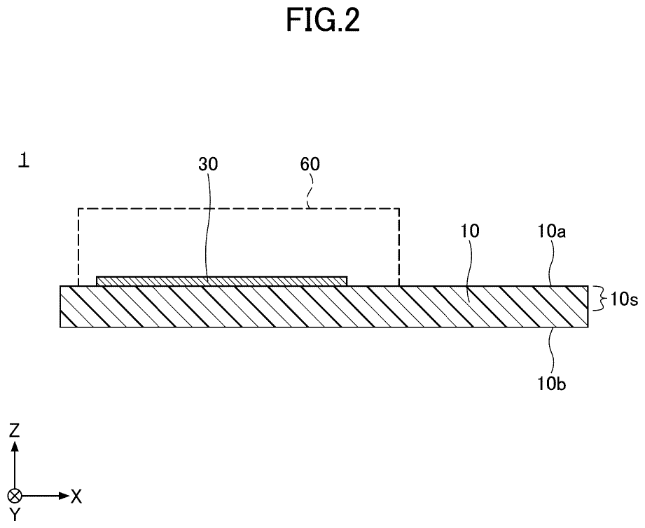

FIG. 1 is a plan view illustrating a strain gauge according to a first embodiment. FIG. 2 is a sectional view (part 1) illustrating the strain gauge according to the first embodiment, and is a sectional view taken along the line A-A in FIG. 1.

Referring to FIGS. 1 and 2, a strain gauge 1 includes a substrate 10, a resistor 30, lines 40, electrodes 50, and a cover layer 60. The cover layer 60 can be provided as needed. In FIGS. 1 and 2, only an outer edge of the cover layer 60 is indicated by a broken line for convenience. Components constituting the strain gauge 1 will be described in detail as follows.

In the present embodiment, for convenience, a side of the strain gauge 1 where the resistor 30 of the substrate 10 is provided will be referred to as an “upper side,” and a side of the strain gauge 1 where the resistor 30 is not provided will be referred to as a “lower side.” Further, a surface located on the upper side of each component will be referred to as an “upper surface,” and a surface located on the lower side of each component will be referred to as a “lower surface.” However, the strain gauge 1 can be used in a state of being upside down. The strain gauge 1 can be also arranged at an arbitrary angle. A plan view refers to viewing an object in a direction that is normal to an upper surface 10a of the substrate 10 and that is from the upper side to the lower side. A plan shape refers to a shape of an object when the object is viewed in the above normal direction.

The substrate 10 serves as a base layer for forming the resistor 30 and the like. The substrate 10 is flexible. The thickness of the substrate 10 is not particularly limited, and may be suitably determined in accordance with the purpose of use of the strain gauge 1. For example, the thickness of the substrate 10 may be approximately 5 μm to 500 μm. A flexure element may be bonded to the lower surface of the strain gauge 1 via an adhesive layer or the like. In view of the transmissibility of strain from a flexure element surface to a sensitive portion and of dimensional stability against environmental changes, the thickness of the substrate 10 is preferably in the range of 5 μm to 200 μm. In view of the insulation, the thickness of the substrate 10 is preferably 10 μm or more.

The substrate 10 is made of a resin and has an elastic modulus of greater than 9.8 GPa. Examples of such a substrate 10 include a liquid crystal polymer (LCP) resin that can have an elastic modulus of up to about 30 GPa. Alternatively, a greater elastic modulus is obtained by surface treatment, and as a result, a resin material having an elastic modulus of greater than 9.8 GPa may be used as the substrate 10.

For example, by irradiating a commercially available polyimide film with energy and heating the polyimide film to thereby carbonize at least a region 10s on an upper surface 10a-side (a side where the resistor 30 is to be formed) of the substrate 10, the elastic modulus can become greater than 9.8 GPa. The elastic modulus of the commercially available polyimide film is 9.8 GPa or less. The energy delivered to the substrate 10 is, for example, ultraviolet light. The energy delivered to the substrate 10 may be a laser beam.

In addition, the elastic modulus may become greater than 9.8 GPa by placing the commercially available polyimide film in a heating furnace or the like and by heating the polyimide film to thereby graphitize at least the region 10s on the upper surface 10a-side of the substrate 10 (the side where the resistor 30 is to be formed). A heating temperature at which the commercially available polyimide film is heated and graphitized is, for example, approximately 2000° C. to 3000° C. A condition such as the heating temperature may allow the polyimide to contain a carbonized portion and a graphitized portion.

In order to increase the elastic modulus of the substrate 10, only the region 10s on the upper surface 10a-side of the substrate 10 may be carbonized and/or graphitized, and the entire substrate 10 in a thickness direction may be carbonized and/or graphitized. When the substrate 10 is completely carbonized and/or graphitized, the elastic modulus of the substrate 10 is about 200 GPa.

When toughness is reduced by carbonizing and/or graphitizing the entire substrate 10 in the thickness direction, only the upper surface 10a-side of the substrate 10 is preferably carbonized and/or graphitized. In this case, the thickness of the region 10s to be carbonized and/or graphitized is preferably 10% or more the thickness of the substrate 10.

A degree of carbonization and/or graphitization of the substrate 10 may be decreased toward the lower surface 10b-side from the upper surface 10a-side. In this case, the degree of carbonization and/or graphitization of the substrate 10 may be continuously changed from the upper surface 10a-side toward the lower surface 10b-side.

An insulating resin film to be carbonized and/or graphitized is not limited to the polyimide film, and for example, an insulating resin film such as an epoxy resin, a PEEK (polyetheretherketone) resin, a PEN (polyethylene naphthalate) resin, a PET (polyethylene terephthalate) resin, a PPS (polyphenylene sulfide) resin, or a polyolefin resin may be adopted. Here, a film refers to a flexible member having a thickness of about 500 μm or less.

In the substrate 10, for example, a commercially available LCP resin is irradiated with energy and heated to thereby flatten the surface. By flattening the surface, the resistor 30 can be deposited uniformly on the substrate 10, and thus electrical stability of the resistor 30 can be increased. Here, the flattening means that surface roughness (Ra) is 30 nm or less.

The insulating resin film that constitutes the substrate 10 may contain fillers, impurities, and the like. For example, the substrate 10 may be formed of an insulating resin film containing fillers such as silica or alumina.

The elastic modulus can be measured by performing dynamic viscoelastic measurement. The elastic modulus disclosed herein is an elastic modulus of the entire substrate 10, and is not an elastic modulus of a partially carbonized and/or graphitized region.

The resistor 30 is a thin film formed in a predetermined pattern on one side (upper side in FIG. 1 and FIG. 2) of the substrate 10. In the strain gauge 1, the resistor 30 is a sensitive portion that changes the resistance upon receiving strain. The resistor 30 may be formed directly on the upper surface 10a of the substrate 10, or may be formed above the upper surface 10a of the substrate 10 via other layer(s). In FIG. 1, the resistor 30 is shown in a matte-finish pattern having a high density for convenience.

The resistor 30 has a structure in which a plurality of elongated portions are arranged at predetermined intervals in the same direction (the X direction in the example of FIG. 1) as a longitudinal direction, and in which ends of adjacent elongated portions are alternately connected and folded zigzag as a whole. Each longitudinal direction of the plurality of elongated portions is a grid direction, and a direction perpendicular to the grid direction is a grid width direction (the Y direction in the example of FIG. 1).

The −X side end of the elongated portion of the resistor 30 on the far +Y side is bent in the +Y direction and reaches one end 30e₁ of the resistor 30 in the grid width direction. The −X side end of the elongated portion of the resistor 30 on the far −Y side is bent in the −Y direction and reaches the other end 30e₂ of the resistor 30 in the grid direction. The respective ends 30e₁ and 30e₂ are electrically connected to electrodes 50 via the lines 40. In other words, the lines 40 electrically connects the ends 30e₁ and 30e₂ of the resistor 30 in the grid width direction to the electrodes 50, respectively.

The resistor 30 can be formed of, for example, a material including Cr (chromium), a material including Ni (nickel), or a material including both Cr and Ni. That is, the resistor 30 can be formed of a material including at least one of Cr or Ni. The material including Cr includes, for example, a Cr composite film. The material including Ni includes, for example, Cu—Ni (copper-nickel). The material including both Cr and Ni includes, for example, Ni—Cr (nickel-chromium).

Here, the Cr composite film is a composite film of Cr, CrN, and Cr₂N, and the like. The Cr composite film may include incidental impurities such as chromium oxide.

The thickness of the resistor 30 is not particularly limited, and may be suitably determined for the purpose of use of the strain gauge 1. For example, the thickness of the resistor 30 may be approximately 0.05 μm to 2 μm. In particular, when the thickness of the resistor 30 is 0.1 μm or more, crystallinity (example, crystallinity of α-Cr) of a crystal that constitutes the resistor 30 is improved. When the thickness of the resistor 30 is 1 μm or less, (i) cracks in the film, and (ii) warpage of the film from the substrate 10, caused by internal stress of the film that constitutes the resistor 30 are reduced.

In consideration of preventing lateral sensitivity from occurring and taking measures against disconnection, the width of the resistor 30 is preferably greater than or equal to 10 μm and less than or equal to 100 μm. More specifically, the width of the resistor 30 is preferably greater than or equal to 10 μm and less than or equal to 70 μm, and more preferably greater than or equal to 10 μm and less than or equal to 50 μm.

For example, when the resistor 30 is a Cr composite film, the stability of the gauge factor can be improved by using α-Cr (alpha chromium), which has a stable crystal phase, as a main component. For example, when the resistor 30 is the Cr composite film, in a case where the resistor 30 is formed with α-Cr as the main component, the gauge factor of the strain gauge 1 can be set to 10 or more, and a gauge factor temperature coefficient TCS and a temperature coefficient of resistance TCR can be each set to be in the range of −1000 ppm/° C. to +1000 ppm/° C. Here, the “main component” means a component at 50 wt. % or more all materials constituting the resistor. From the viewpoint of improving the gauge factor, the resistor 30 preferably includes α-Cr at 80 wt. % or more. Further, from this viewpoint, it is more preferable that the resistor 30 includes α-Cr at 90 wt. % or more. The α-Cr is Cr having a bcc structure (body-centered cubic lattice structure).

When the resistor 30 is the Cr composite film, CrN and Cr₂N included in the Cr composite film are preferably at 20 wt. % or less. When CrN and Cr₂N included in the Cr composite film are at 20 wt. % or less, it is possible to suppress the decrease in the gauge factor of the strain gauge 1.

It is preferable that a ratio of CrN to Cr₂N in the Cr composite film is greater than or equal to 80 wt. % and less than 90 wt. % with respect to a total weight of CrN and Cr₂N. More preferably, the ratio is greater than or equal to 90 wt. % and less than 95 wt. % with respect to the total weight of CrN and Cr₂N. Cr₂N has a semiconductor characteristic. Therefore, when a percentage of Cr₂N is greater than or equal to 90 wt. % and less than 95 wt. %, a decrease in TCR (negative TCR) becomes more remarkable. Furthermore, when the percentage of Cr₂N is greater than or equal to 90 wt. % and less than 95 wt. %, a ceramic portion of the resistor 30 is reduced, and a brittle fracture of the resistor 30 is unlikely to occur.

On the other hand, CrN has an advantage of being chemically stable. By including more CrN in the Cr composite film, it is possible to reduce the possibility of generating unstable N, so that a stable strain gauge can be obtained. Here, the “unstable N” means a small amount of N₂ or atomic N that may exist in the film of the Cr composite film. The unstable N may escape out of the film depending on an external environment (for example, a high temperature environment). When the unstable N escapes out of the film, film stress on the Cr composite film may change.

When the Cr composite film is used as the material of the resistor 30 in the strain gauge 1, high sensitivity can be provided and the strain gauge 1 can be made compact. For example, while the output of a conventional strain gauge is about 0.04 mV/2 V, the output of 0.3 mV/2 V or more can be obtained in a case where the Cr composite film is used as the material of the resistor 30. In addition, while the size (gauge length×gauge width) of the conventional strain gauge is about 3 mm×3 mm, the size (gauge length×gauge width) of the strain gauge can be reduced to about 0.3 mm×0.3 mm in a case where the Cr composite film is used as the material of the resistor 30.

The lines 40 are provided on the substrate 10. Each of the lines 40 is electrically connected to the resistor 30 and a corresponding electrode among the respective electrodes 50. The line 40 is not limited to a linear shape, and may have any pattern. The line 40 may have any width and any length. In FIG. 1, for convenience, the line 40 is shown in a crepe pattern having a density that is lower than that of the resistor 30.

The electrodes 50 are provided on the substrate 10. The respective electrodes 50 are electrically connected to the resistor 30 via the lines 40. In a plan view, each electrode 50 is formed to have a substantially rectangular shape and is wider than the line 40. The electrodes 50 makes a pair of electrodes for externally outputting a change in the resistance of the resistor 30 due to strain. For example, a lead wire for an external connection or the like is bonded to each electrode 50. A metal layer, such as copper, having a low resistance, or a metal layer, such as gold, having good solderability may be laminated on the upper surface of each electrode 50. Although the resistor 30, the line 40, and the electrode 50 are denoted by different numerals for convenience, these can be integrally formed by the same material in the same process. In FIG. 1, the electrodes 50 are each shown in a matte-finish pattern having the same density as described in the lines 40, for convenience.

The cover layer 60 (protective layer) is provided on and above the upper surface 10a of the substrate 10 as necessary, so as to cover the resistor 30 and the lines 40 and expose the electrodes 50. The material of the cover layer 60 may include, for example, an insulating resin, such as a PI resin, an epoxy resin, a PEEK resin, a PEN resin, a PET resin, a PPS resin, a composite resin (for example, a silicone resin or a polyolefin resin), or the like. The cover layer 60 may contain fillers or pigments. The thickness of the cover layer 60 is not particularly limited and can be suitably selected according to the purpose. For example, the thickness of the cover layer 60 may be approximately 2 μm to 30 μm. By providing the cover layer 60, the occurrence of mechanical damage or the like to the resistor 30 can be suppressed. Further, by providing the cover layer 60, the resistor 30 can be protected from moisture or the like.

### [Reduction of Creep]

It is preferable that the strain gauge 1 has excellent creep characteristics. That is, it is preferable that a creep amount and a creep recovery amount of the strain gauge 1 are small. For example, if each of the creep amount and the creep recovery amount can be reduced to a predetermined value or less, the strain gauge 1 can be adopted not only for a sensor application but also for a weighing application.

When the strain gauge is used for the weighing application, it is necessary to satisfy standards related to the creep. The standards related to the creep include, for example, an accuracy class C1 (hereinafter may be referred to as a C1 standard) based on OIML R60, an accuracy class C2 (hereinafter may be referred to as a C2 standard), and an accuracy class C3 (hereinafter may be referred to as a C3 standard).

In the C1 standard, each of the creep amount and the creep recovery amount needs to be from −0.0735% to +0.0735%. In the C2 standard, each of the creep amount and creep recovery amount needs to be from −0.0368% to +0.0368%. In the C3 standard, each of the creep amount and creep recovery amount needs to be from +0.016% to −0.016%. When the strain gauge 1 is used for the sensor application, the standard for each of the creep amount and creep recovery amount approximately defines from −0.5% to +0.5%.

The creep amount and creep recovery amount for the strain gauge are influenced by viscoelasticity of a constituent material. In general, creep does not occur in a metal material that is an elastic material, but the creep occurs in a resin that is a viscous material. The substrate 10 made of the resin is used in the strain gauge 1, and thus the viscosity of the substrate 10 is not negligible.

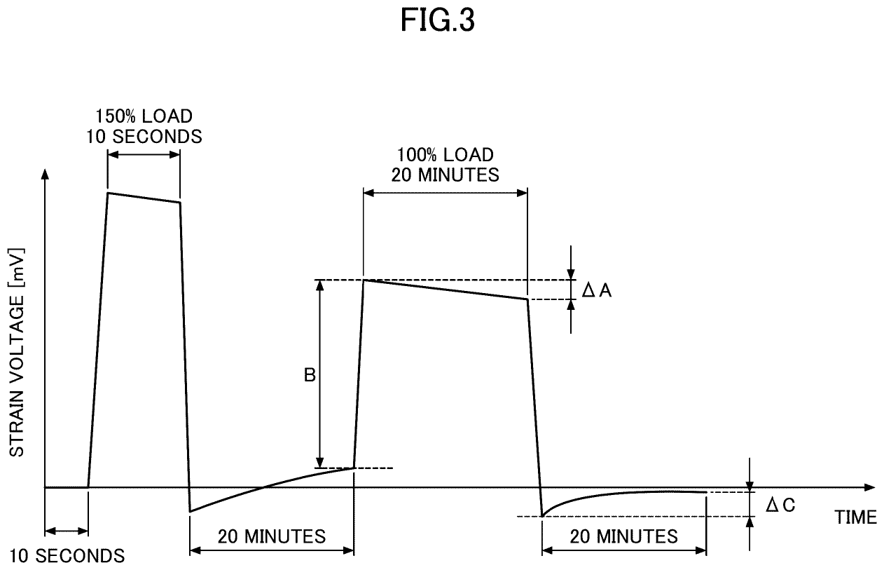

In the strain gauge 1, the creep amount and the creep recovery amount are determined by the fact that an amount (strain amount) of elastic deformation of the surface of the substrate 10 on which the resistor 30 is provided changes over time. In this arrangement, the creep amount and the creep recovery amount can be measured by monitoring the strain voltage that is calculated based on the output between the pair of electrodes 50 of the strain gauge 1. A detailed description will be provided below with reference to FIG. 3.

FIG. 3 is a diagram for describing the method for measuring the creep amount and the creep recovery amount. In FIG. 3, the horizontal axis represents the time, and the vertical axis represents the strain voltage [mV].

First, 10 seconds after powering a measuring apparatus, a 150% load is applied to the strain gauge 1 that is attached to the flexure element, for 10 seconds, and subsequently, the strain gauge 1 is unloaded. 20 minutes after unloading, a 100% load is applied to the strain gauge 1 attached to the flexure element, for 20 minutes, and subsequently, the strain gauge 1 is unloaded. Finally, wait for 20 minutes after unloading.

The strain voltage changes, for example, as shown in FIG. 3. In FIG. 3, an absolute value B of a difference in the strain voltage between a time point 20 minutes after the 150% load is removed and a time point immediately after the 100% load is applied is measured. Also, an absolute value ΔA of a difference in the strain voltage between a time point immediately after the 100% load is applied and a time point 20 minutes after the 100% load is applied is measured. In this case, ΔA/B is the creep amount. Next, an absolute value ΔC of a difference in the strain voltage between a time point immediately after the 100% load is removed and a time point 20 minutes after the 100% load is removed is measured. In this case, ΔC/B is the creep recovery amount.

The 100% load is 3 kg, and the 150% load is 1.5 times the 100% load.

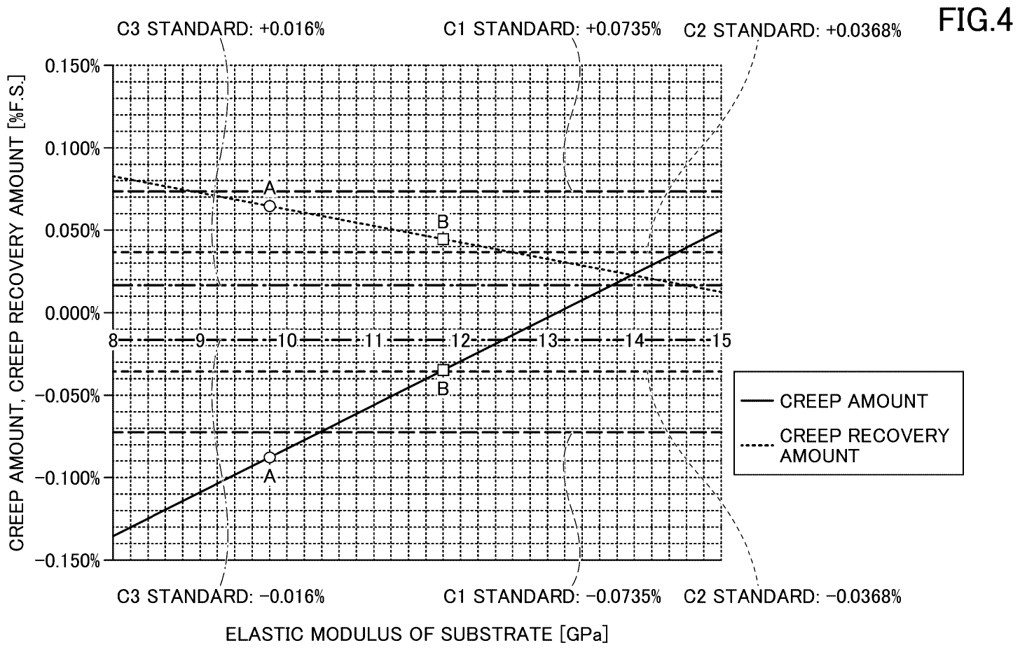

FIG. 4 shows a study result for the creep amount and the creep recovery amount. A measurement result is summarized as follows.

First, two measurement samples of strain gauges, namely a measurement sample A and a measurement sample B are prepared. A difference between the measurement sample A and the measurement sample B is only whether a polyimide film as the substrate is subjected to surface treatment. Specifically, the difference is as follows.

In the measurement sample A, as the substrate 10, a polyimide film that has a film thickness of 25 μm and that is not subjected to surface treatment is used. Further, as the resistor 30, a Cr composite film is used. As the cover layer 60, a polyimide film that has a film thickness of 15 μm and that is not subjected to surface treatment is used. In the measurement sample A, when the elastic modulus of the substrate is measured, the elastic modulus is 9.8 GPa.

In the measurement sample B, a polyimide film that has a film thickness of 25 μm and that is subjected to surface treatment is used as the substrate 10. That is, at least an upper surface side of the substrate used as the measurement sample B is carbonized and/or graphitized. A Cr composite film is used as the resistor 30. A polyimide film that has a thickness of 15 μm and that is not subject to surface treatment is used as the cover layer 60. When the elastic modulus of the substrate is measured for the measurement sample B, the elastic modulus is 11.8 GPa.

Next, the respective measurement samples A and B are bonded on separate flexure elements that are specified by SUS304, and then creep amounts and creep recovery amounts are measured by the measurement method shown in FIG. 3. The result shown in FIG. 4 is obtained based on the knowledge from the inventors in which the elastic modulus of the substrate is approximately proportional to each of the creep amount and creep recovery amount, and on the measurement results for the measurement samples A and B. In FIG. 4, data indicated by circles is data for the measurement sample A, and data indicated by squares is data for the measurement sample B.

As shown in FIG. 4, each of the creep amount and the creep recovery amount is decreased in accordance with an increasing elastic modulus of the substrate. For example, when the elastic modulus of the substrate is 10.4 GPa or more, the creep amount and the creep recovery amount as specified in the C1 standard can be satisfied. When the elastic modulus of the substrate is 12.6 GPa or more, the creep amount and the creep recovery amount as specified in the C2 standard can be satisfied. When the elastic modulus of the substrate is 14.7 GPa or more, the creep amount and the creep recovery amount as specified in the C3 standard can be satisfied.

As described above, when the polyimide film having the elastic modulus of greater than 9.8 GPa is used as the substrate 10 in the strain gauge 1, the creep can be reduced compared to a case where a commercially available polyimide film having an elastic modulus of 9.8 GPa or less is used. In particular, when the polyimide film having an elastic modulus of greater than 10.4 GPa is used as the substrate 10 in the strain gauge 1, the strain gauge 1 can be also used for the weighing application.

Although the experimental results using the polyimide film are shown above, as described above, the insulating resin film to be carbonized and/or graphitized is not limited to the polyimide film, and any other insulating resin film may be used. In this case, for the creep amount and the creep recovery amount, the C1 standard is satisfied when the elastic modulus of the substrate is 10.4 GPa or more, the C2 standard is satisfied when the elastic modulus of the substrate is 12.6 GPa or more, and the C3 standard is satisfied when the elastic modulus of the substrate is 14.7 GPa or more. For example, when a liquid crystal polymer (LCP) is used, the LCP can have an elastic modulus of up to about 30 GPa, and as a result, the creep can be reduced.

When a highly sensitive strain gage (for example, in a case or the like where a Cr composite film is used as the resistor 30) has a gauge factor of 10 or more, the strain gauge is sensitive to physical properties of the material because the strain gage has high sensitivity. In this case, creep characteristics may be remarkably degraded. Therefore, in the highly sensitive strain gage having the gauge factor of 10 or more, it is extremely important to improve the creep characteristics by controlling the elastic modulus of the substrate.

### [Method for Manufacturing Strain Gage]

Hereinafter, a method for manufacturing the strain gage 1 will be described. In order to manufacture the strain gage 1, an insulating resin film having an elastic modulus of greater than 9.8 GPa is prepared as the substrate 10. Then, a metal layer (which may be referred to as a metal layer A for convenience) is formed on the upper surface 10a of the substrate 10. The metal layer A is a layer that is finally patterned to form the resistor 30, the lines 40, and the electrodes 50. In this arrangement, the material and the thickness of the metal layer A are the same as described in the resistor 30, the lines 40, and the electrodes 50.

The metal layer A can be formed, for example, by magnetron sputtering that uses a raw material capable of forming the metal layer A as a target. Instead of magnetron sputtering, the metal layer A may be formed by reactive sputtering, vapor deposition, arc ion plating, pulsed laser deposition, or the like. After depositing the metal layer A on the upper surface 10a of the substrate 10, the metal layer A is patterned to have the same planar shape as described in the resistor 30, the lines 40, and the electrodes 50 shown in FIG. 1 by any known photolithography.

The metal layer A may be formed after forming a base layer on the upper surface 10a of the substrate 10. For example, a functional layer having a predetermined film thickness may be vacuum-deposited on the upper surface 10a of the substrate 10 by conventional sputtering. By providing the base layer in this manner, gauge characteristics of the strain gauge 1 can be stabilized.

In the present application, the functional layer refers to a layer having a function of promoting crystal growth of at least an upper metal layer A (resistor 30). Preferably, the functional layer further has a function of preventing oxidation of the metal layer A due to oxygen or moisture contained in the substrate 10 and/or a function of improving adhesion between the substrate 10 and the metal layer A. The functional layer may further have other functions.

The insulating resin film that constitutes the substrate 10 may contain oxygen or moisture, and Cr may form an autoxidized film. In this case, especially when the metal layer A includes Cr, it is preferable to form a functional layer having a function of preventing oxidation of the metal layer A.

With this arrangement, by providing the functional layer under the metal layer A, crystal growth of the metal layer A can be promoted, and the metal layer A having a stable crystal phase can be produced. As a result, the stability of the gauge characteristics is improved in the strain gauge 1. Moreover, the gauge characteristics are improved in the strain gauge 1 by diffusing a material constituting the functional layer into the metal layer A.

The material of the functional layer may include, for example, one or more metals selected from the group consisting of Cr (chromium), Ti (titanium), V (vanadium), Nb (niobium), Ta (tantalum), Ni (nickel), Y (yttrium), Zr (zirconium), Hf (hafnium), Si (silicon), C (carbon), Zn (zinc), Cu (copper), Bi (bismuth), Fe (iron), Mo (molybdenum), W (tungsten), Ru (ruthenium), Rh (rhodium), Re (rhenium), Os (osmium), Ir (iridium), Pt (platinum), Pd (palladium), Ag (silver), Au (gold), Co (cobalt), Mn (manganese), and Al (aluminum); an alloy of any metals among the group; or a compound of any metal among the group.

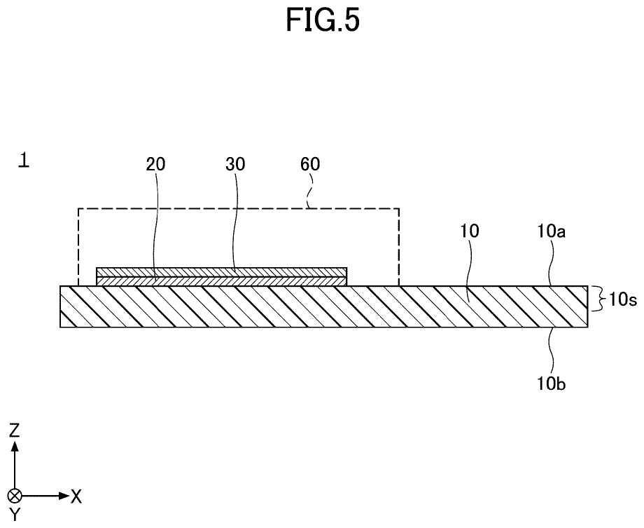

FIG. 5 is a cross-sectional view (part 2) illustrating the strain gauge according to the first embodiment. FIG. 5 shows a cross-sectional shape of the strain gauge 1 when the functional layer 20 is provided as an underlayer of the resistor 30, the lines 40, and the electrodes 50.

The planar shape of the functional layer 20 may be patterned to be substantially the same as the planar shape of the resistor 30, the lines 40, and the electrodes 50, for example. However, the planar shape of the functional layer 20 may not be substantially the same as the planar shape of the resistor 30, the lines 40, and the electrodes 50. For example, when the functional layer 20 is formed of an insulating material, the functional layer 20 may be patterned to have a shape different from the planar shape of the resistor 30, the lines 40, and the electrodes 50. In this case, the functional layer 20 may be formed in a solid shape in a region where the resistor 30, the lines 40, and the electrodes 50 are formed, for example. Alternatively, the functional layer 20 may be solidly formed on the entire upper surface of the substrate 10.

After forming the resistor 30, the lines 40, and the electrodes 50, the cover layer 60 is formed on and above the upper surface 10a of the substrate 10 as required. The cover layer 60 covers the resistor 30 and the lines 40, but the electrodes 50 may be exposed from the cover layer 60. For example, the cover layer 60 can be formed by laminating a semi-cured thermosetting insulating resin film on the upper surface 10a of the substrate 10 so as to cover the resistor 30 and the lines 40 and expose the electrodes 50, and subsequently, by heating and curing the insulating resin film. The strain gauge 1 is completed by the above process.

### <Modification 1 of First Embodiment>

The modification 1 of the first embodiment is described using an example in which a material having a greater elastic modulus is used in the cover layer. In the modification 1 of the first embodiment, description of the same components as described in the above embodiments may be omitted.

In the first embodiment, a general resin material is illustrated as the cover layer 60. In this case, the elastic modulus of the cover layer 60 is 9.8 GPa or less. However, in addition to the elastic modulus of the substrate 10, the elastic modulus of the cover layer 60 is preferably greater than 9.8 GPa. As a result, creep characteristics of the strain gauge 1 can be further improved.

For example, as the cover layer 60, an insulating resin film such as a polyimide film having an elastic modulus of greater than 9.8 GPa can be used. In this case, the elastic modulus can become greater than 9.8 GPa by performing the surface treatment shown in the first embodiment on the surface of an insulating resin film, such as a commercially available polyimide film. For example, as the cover layer 60, a liquid crystal polymer (LCP) resin having an elastic modulus of up to about 30 GPa can be used.

An inorganic material may be used as the cover layer 60. Examples of the inorganic material include a metal, such as Cu, Cr, Ni, Al, Fe, W, Ti, or Ta, and may include an oxide, a nitride, or a nitrogen oxide of alloys, including the metals described above. A semiconductor, such as Si or Ge, may be used as the inorganic material, or alternatively, an oxide, a nitride, or nitrogen oxide, including Si, Ge, or the like may be used as the inorganic material. When the cover layer 60 is an inorganic material, the cover layer can be deposited by dipping, screen printing, sputtering, CVD, or the like.

The preferred embodiments and the like are described in detail. However, the strain gauge in the present disclosure is not limited to the above-described embodiments and modifications. For example, various modifications and substitutions can be made to the strain gauge according to the above-described embodiments and the like without departing from the scope described in the claims.

This international application claims priority to Japanese Patent Application No. 2022-039237, filed on Mar. 14, 2022, the entire contents of which are incorporated herein by reference.

### DESCRIPTION OF SYMBOLS

1 strain gauge, 10 substrate, 10a upper surface, 10b lower surface, 10s region, 20 functional layer, 30 resistor, 40 line, 50 electrode, 60 cover layer

1. A strain gauge comprising:
a substrate made of a resin; and
a resistor situated on one surface side of the substrate and formed of a film that includes Cr, CrN, and Cr₂N,
wherein an elastic modulus of the substrate is greater than 9.8 GPa.

2. The strain gauge according to claim 1, wherein at least one surface side of the substrate is carbonized and/or graphitized.

3. The strain gauge according to claim 2, wherein a degree of carbonization and/or graphitization is decreased from the one surface side toward the other surface side.

4. The strain gauge according to claim 3, wherein the degree of carbonization and/or graphitization varies continuously from the one surface side toward the other surface side.

5. The strain gauge according to claim 1, wherein one surface of the substrate provides a protective layer that covers the resistor, and
wherein an elastic modulus of the protective layer is greater than 9.8 GPa.

6. The strain gauge according to claim 1, wherein an elastic modulus of the substrate is greater than or equal to 10.4 GPa.

7. The strain gauge according to claim 1, wherein an elastic modulus of the substrate is greater than or equal to 12.6 GPa.

8. The strain gauge according to claim 1, wherein an elastic modulus of the substrate is greater than or equal to 14.7 GPa.

9. The strain gauge according to claim 1, wherein a gauge factor of the strain gauge is 10 or more.
